(19) United States
(12) Patent Application Publication
(10) Pub. No.: US 2003/0061029 A1
(43) Pub. Date: Mar. 27, 2003

(54) Device for conducting expectation based mixed initiative natural language dialogs

(76) Inventor: Efraim Shaket, Netanya (IL)

Correspondence Address: FISH & RICHARDSON PC, 225 FRANKLIN ST, BOSTON, MA, 02110, US

(21) Appl. No.: 10/229,943

(22) Filed: Aug. 28, 2002

Related U.S. Application Data
(60) Provisional application No. 60/315,670, filed on Aug. 29, 2001.

(51) Int. Cl. G06F 17/27

(52) U.S. Cl. 704/9

(57) ABSTRACT

A method for conducting an expectation based Mixed-Initiative Dialog between parties in natural language in order to perform a task, at least where one party is a machine. The first party takes the initiative, takes a turn in the dialog by generating utterances. The second party, in response to the generated utterances, takes a turn in the dialog and generates the reply utterances. A cycle of steps is repeated, including mutual and successive utterances, indications and acknowledgements.

### FIELD AND BACKGROUND OF THE INVENTION

People have interacted with computer systems in an interactive mode since the 1960's when computers became accessible to individuals. This interaction was invariably in the form of a command language where the user has to know in details the commands available and their formats. As computers grew more powerful and more complex the interaction became more complex and more onerous and demanding on the user.

In the late '70's the Windows graphic interface was invented at Xerox PARC and the era of GUI (Graphical User Interfaces) was ushered in. The user just has to point with the mouse to graphical objects on the screen select optional actions from menus presented to them and the desired action was performed by the system.

The ultimate human-computer interface, however, always remains the native Natural Language, like English in the US or French in France. If only people could say in their native Natural Language what they want done, and the computer would “Understand” what they mean in the context of the situation and proceed to perform the desired task, optionally asking for some additional information or clarification before performing the task. Every person has command of at least one Natural Language and he would not have to know or learn any arcane command language, or learn the complex functionality of the system before he can sit down and use it for the first time.

The goal of building Natural Language Interfaces became the target of much research and development, in particular in the area of Artificial Intelligence. In the 80's and 90's Speech Recognition systems started to appear, and the systems progressed in speed, capacity and accuracy of the recognition as the personal computers progressed in power from 1 MIPS (Million Instruction Per Second) in 1995 to 1 GIPS (Giga Instruction Per Second). The capabilities improved from recognizing tens of words (like in speech dialing) to thousands of words, to speaker dependent dictation systems with 65000 words vocabulary performed in real time in 1995, Recent dictation and ASR (Automatic Speech Recognition) systems are more accurate and are “speaker independent” they can attain good enough recognition level for almost any speaker without the need for training it for the individual user. Systems of this kind reached performance levels of 93%-95% if the input was through a good microphone. Using the Telephone as the input device, the performance deteriorated sharply to the range of 60% to 70% even for a vocabulary of a few hundred words. Linguistic information of higher levels needs to be incorporated in order to raise the recognition rates to acceptable levels. Commercial IVR systems (Interactive Voice Response) use simple graph grammars of English (Syntax information) and more recently some systems use HMM (Hidden Markov Models) of Syntax to improve the recognition accuracy.

IVR Systems for Rigid Structure Dialogs.

Current IVR systems (Interactive Voice Response) usually employ a predefined Transition Graph form of the Dialog. Where at each node the system issues a fixed Voice Prompt and presents to the ASR module a Language Model with a fixed set of alternatives. The ASR analyzes the user's responses and the system decides which alternative out of the fixed set, was the actual response. It proceeds to follow that path in the Transition Graph. The IVR systems usually take the initiative in the dialog and prompt the user through a rigid sequence of steps without allowing him to respond in more than one or a few predefined words.

To make such JVR system able to interact in a more natural way, the system constructor has to provide hundreds (or even thousands) of scripts in both the Language Model at each point, and different paths through the Transition Graphs representing different possible sequences of utterances in the Dialog, which may transpire with different users.

Europe NL Research

The European Community has invested heavily in NLP, NLU and Dialog systems. Among others in the 1994-1998 projects called FRACAS.

DARPA Communicator Project

DARPA has started the Communicator program where many universities and major research organizations strive to develop the “next generation of intelligent conversational (NL) interfaces to distributed computer information” the project started in 1999 and continues through 2001.

Book References:

“Natural Language Understanding” by James Allen (Benjamin/Cummings Publ. 1995) ISBN 0-8053-0334-0 pages 465-473.

“Speech and Language Processing—an Introduction to Natural Language Processing, Computational Linguistics and Speech. Processing.” Daniel Jurafsky and James H. Martin (Prentice Hall 2000) ISBN 0-13-095069-6 pages 719-758.

“Survey of the State of the Art in Human Language Technology” by R. Cole et Al. (Cambridge University Press 1997) ISBN 0-521-59277-1 pages 199-214

### SUMMARY OF THE INVENTION

The invention provides for a method for conducting an expectation based Mixed-Initiative Dialog between parties in natural language in order to perform at least one task, at least said first party being a machine, the method comprising the steps of;

a) the first party taking initiative;

b) the first party taking a turn in the dialog by generating at least one utterance; the semantics and pragmatics of said at least one utterance selectively fall in one of the following three levels 1) the current world model; 2) the dialog itself; and 3) the at least one task and at least one goal that the first party wants to perform; the speech acts, semantics and pragmatics implied expectations;

c) the second party, in response to said generated at least one utterance, taking a turn in the dialog and generating at least one reply utterance;

d) the first party interpreting the at least one reply utterance so as to create a semantic and pragmatic description thereof and the speech acts associated therewith; the first party checking whether the semantics pragmatics and speech acts of the at least one reply utterance fall within said implied expectations and if the affirmative

e) performing the steps (b) to (d) cycle as many times as required whilst the initiative is with the first party; during said cycles the first party selectively modifying any one of the levels 1) the current world model; 2) the dialog itself, and 3) the at least one task and at least one goal that the first party wants to perform; the second party being responsive to the generated at least one utterance in said step (b) and generating at least one reply utterance in said step (c);

f) if the first party (in d) while checking whether the semantics, pragmatics and speech acts of the at least one reply utterance does not find it falling within said implied expectations, the first party identifying a change in the initiative which includes one of the following three levels:

(i) a change in the dialog goal, responsive to which the first party changing its current goal; or

(ii) a change in the dialog structure, responsive to which, the first party changing the dialog itself, or

(iii) a change in the current world model, responsive to which, the party changing the world model appropriately;

h) the first party generating at least an acknowledgement utterance indicating an acceptance of change in the initiative; the second party taking a turn and generating at least one utterance;

i) the first party interpreting the at least one utterance received in (h) so as to create a semantic and pragmatic description thereof and the speech acts associated therewith and derive therefrom the implied expectations of the second party;

j) the first party checking whether it can reply appropriately and generate at least one utterance which falls within the expectations derived in said (i), and if in the affirmative then the first party taking a turn in the dialog and generating as a response the at least one utterance;

k) performing the steps (h) to (j) cycle as many times as required whilst the initiative is with the second party

l) otherwise, if in response to said checking in step (j) the first party cannot generate at least one utterance which falls within the expectations, the fist party generating an utterance indicating that it takes the initiative; and after receiving an acknowledgement performing step (b).

The present invention further embraces a counterpart system and a storage medium that stores a computer program code for implementing the method of the invention.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 is the Natural Language Dialog System Block Diagram, according to one embodiment of the invention.

FIG. 2 is the Mixed Initiative Dialog Manager, according to one embodiment of the invention.

FIG. 3 is a Sample dialog with Mixed-Initiative according to one embodiment of the invention.

FIG. 4 is The Context Tree for the Sample Dialog according to one embodiment of the invention.

FIG. 5 is the Flow of Mixed Initiative Dialog according to one embodiment of the invention.

FIG. 6 is a Rules Generated by the Task Manger for Mixed Initiative i-Response according to one embodiment of the invention.

### DETAILED DESCRIPTION OF A PREFERRED EMBODIMENT

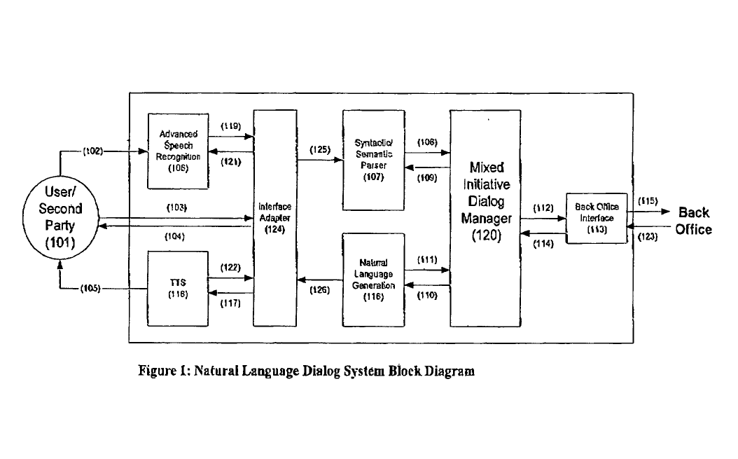

FIG. 1 depicts the overall block diagram of a Natural Language Dialog System that can carry on an extended conversation with a remote human user over the phone or Internet. The User (101 in FIG. 1) can use his Voice (102) through the Telephone or through a Microphone connected over the Net. Or the user may use Text (103) keyed in on a keyboard as the input modality. A non-limited example of text modality is Web chatting over the Internet or Intranet.

The response of the system can also be Voice (105) (through the phone) or text (104) but it can be enhanced with Graphic Multimedia Output if a screen and loudspeakers are provided.

A Dialog is an “Interactive, Extended, Goal Directed, exchange of Meaningful Messages between two (usually) Cooperative Parties striving to attain a shared goal.” Up until recently the two parties where exclusively human. This Provisional Patent defines a device and procedures to build a computer-based device that can take part in a natural, free flowing dialog and play, operationally, the role of one of the parties.

The ASR (Automatic Speech Recognizer) (106)

The ASR translates the Voice input signal (102) into a Text output (or an N-Best Table format), which represents its best analysis of the words (and extra dialog sounds) spoken in the second party's utterance (the User 101). The ASR uses a database of predefined phonetic descriptions of all the words in the Vocabulary DB. It receives (121) from the Interface Adapter (124) a Recognition Grammar of the language expressions it expects to receive in each stage of the Dialog. (the details are outside the scope of this Patent Application)

The Interface Adapter (124)

The Interface Adapter (124) receives text input (103), recognition results or alerts (119) from the ASR (106) and transform it into a unified XML based message. This message is then sent (125) to the Syntactic/Semantic Parser (107).

When the system needs to communicate back to the second party (101), the Natural Language Generator (116) sends its information to the Interface Adapter (126). The Interface Adapter then formats the information according to the target. None limited examples are TTS (117), Plain text (104) or HTML.

The TTS (118) sends alerts to the Interface Adapter (122).

The Syntactic/Semantic Parser (107)

The Syntactic/Semantic Parser (107) takes the Text or recognition results (N-Best Table) output (125) and performs a multilevel analysis on it. The analysis may include Morphological, Lexical, Syntactic, Semantic, Pragmatic Analysis and even Speech Act spotting. Each one of these sub modules requires the relevant Linguistic Knowledge in the form of Rules Frames or Graph representations. The output of the Parser (108) is a Syntactic/Semantic representation of the input Utterance that the system received in the current Turn of the Dialog. The Parser (107) may use information from the Discourse Context (109) (see the Discourse Context Module (226)).

The Mixed Initiative Dialog Manager (120)

The Natural Language Dialog Manager (120) is the heart of the Dialog System. It keeps a representation of the current Dialog Goals (203) the active Plans (205) it executes to achieve these plans, the Dialog Context Tree (207) where all that was said is kept and the Current World Objects (209) the collection of the Objects, Concepts, Data Bases and Transactions that may take part in the dialog. It receives the Semantic/Pragmatic results of the Syntactic/Semantic Parser (108) and generates the proper responses in the Current Dialog through the NLG Module (116) giving it Speech Acts and the Semantics (110) of the response it wants to Utter.

The Natural Language Generator (116)

The Natural Language Generator (116) takes the output of the Dialog Manager (110) which is in the form of a high level Speech Act with its Content (the Semantic and Pragmatic components) and generates the output utterances (126). The output utterance may consist of one word like “yes” or “no” but may be made of one or more sentences or sentence fragments.

### EXAMPLE

User: “Do you know a Chinese restaurant near the Rockefeller Center?”

The System: “yes. There are four Chinese restaurants in the area. The first one is the “Red Emperor”, the second is . . . At which one would you like to eat?”

The Natural Language Generator (116) stores (111) the semantic interpretation of its generated utterance (126), in speech acts and arguments format, on the Discourse Context (226). This information will be later consumed (as dialog expectations) by the Interpretation Manager (211) when interpreting the next user reply utterance.

The Back Office Interface (113)

The Natural Language Dialog Manager (113) may actually carry on two conversations at the same time. While it is conversing with the User (the second party) in speech, it may initiate and respond to one or more short dialogs with other computers in the Back Office of the institution. This conversation is performed through the Back Office Interface (113). These dialogs (115) to the BO, and (123) the response from the BO, are of three general kinds:

1. BO Transactions—The system performs transactions against a back office Data—Base to bring some necessary information into the conversation, or, to perform a Transaction against a Back Office Application.

Example: confirm the validity of the password the user has given.

2. Information Services—provide the ability to translate a User question asked in Natural Language into a formal Query language. And then translating the structured response from the BO into a natural sounding answer to the question.

Example: The user asked, “What are the stock that rose by more than three percent today?” in a Stock Buying Application.

The Dialog Manager takes the output of the semantic Parser (107) and activates a dialog with the StockDailyChanges Data Base and sends a GetInfo Transaction through the Back Office Interface (113) in a form like: (GETINFO (DB StockDailyChanges)

(Restrict (>DailyChange 0.03))

3. Tasks—The actual performance of the Tasks that the user wanted to perform with the assistance of the system. The User carries an extended dialog with the system stating that he wants to buy some shares, gives the amount, discusses the stock selection and decides on the purchase time and price. This whole sub-dialog is understood and responded to appropriately and finally, a complete and verified Transaction request (112) is sent from the Dialog Manager (120) to the Back Office Interface (113). Here it is translated to the proper format and the Transaction Message (116) is sent to the BO. The Confirmation response (123) is presented to the User in English.

The TTS (Text To Speech) Module (118)

The TTS Module (118) inputs Text and Intonation messages (117) that it receives from the NLG Module (116) and translates them to output Voice Utterances that are sent in real time to the Second Party (the User (101)). For this purpose, it uses a phonetic description of each word in its Vocabulary and uses also Phonetic Rules that apply when words are not used in their base form, or when the phonetic pronunciation of the word have to be changed because of the influence of the following or previous word.

### EXAMPLE

“Bob rings” and “Bob brings” would be pronounced the same: “Bobrings”

The Task Manager (201)

The Task Manager (201) is the actual Manager of the Dialog in the sense that:

It sets up the Goals of the Dialog by writing and modifying Goals (202) into the Goals Module (203).

It expands the Current new Goal into its dynamic Plan and puts the plan as the Current Plan (204) into the Plans Module (205).

The Plan Interpreter (225), which is the main component of the Hub Module, interprets the Current Plan Step by Step. The Steps may be Computational or manipulate data, they may involve performing Speech-Acts toward the User (the Second Party) like ASK, TELL, CONFIRM, DENY, INFORM, CHANGE_SUBJECT etc., they may involve interactions against the Back Office, like performing a TRANSACTION, sending a DB QUERY and Interpreting the results, or it may involve changing the Dialog Context (207) and the Current World Objects (209). Most importantly the actions may create new Goals in (203) and new Plans in (205) in response to User Inputs.(212).

Thus the Task Manager (201) may change the Plans in the Plans Module (205). And these may change its direction of progress.

It (205) modifies and uses the Dialog Context in Interpreting the User Inputs.

It (205) may modify the Current World Objects and Use them to build the BO Transactions and Queries (210) and Interpret the Results (217)

And Finally it Generates the sets of Rules for the Interpretation Manager (211) so it can “Understand the meaning and the Intentions” of the User Response (as it comes out of the Semantic/Syntactic Parser (210)) as it relates to the expectations it created from the Current Dialog Context (207).

The Task Manager (201) interacts with the User in complex but highly structured manners called a Mixed Initiative Dialog.

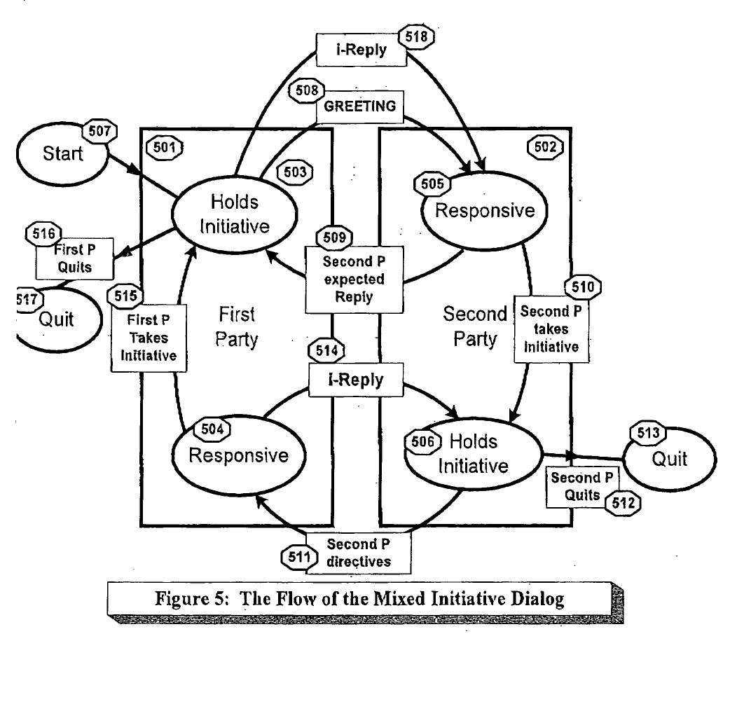

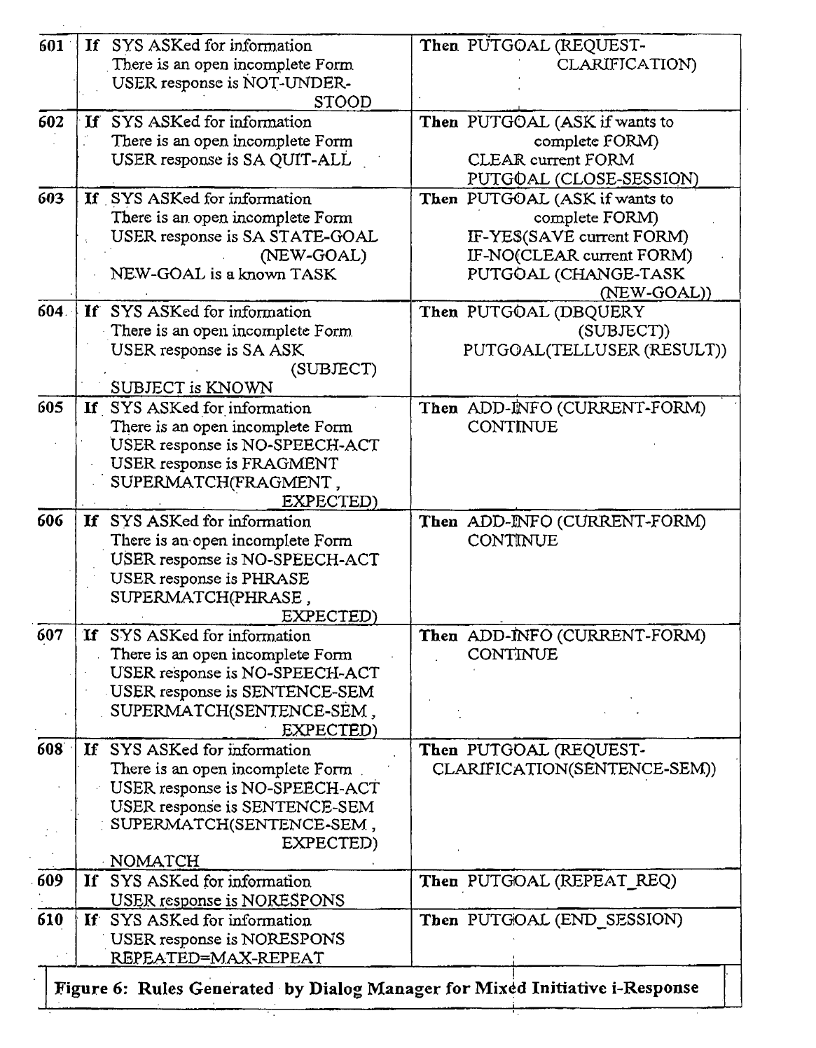

The following Chapters describe the Dialog Flow in FIG. 5, and the details of the Expectation Module Rules in FIG. 6.

The Goals Module (203)

The Goals Module (203) keeps and maintains the current Goals of the Dialog. The user and the system agree on a goal (or goals) that the system will help the user to achieve.

The system may help the user with a set of predefined goals defined per application. The available set of goals is derived from the application ontology and transactions definitions.

The application ontology is a list of related concepts stored in the system knowledge base. The details of the system knowledge base are outside the scope of this patent application.

Transactions are high-level goals usually resembling end user services. Transactions usually span across multiple ontology concepts and include some application logic.

For example:

“I want to buy 150 shares at the market price now”

The transaction here is BUY. The system accepts the goal of performing a BUY transaction. Doing so the system puts a “sub-goal” to collect the missing share name from the user.

The Goals give the conversation a purpose and a direction, and all the utterances are interpreted as intended to assist in achieving the Goals. They are kept on a stack of goals until they are completed successfully or unsuccessfully, or until the system wants to terminate them. Each Goal is associated with one or more Plans that define the specific Steps that would achieve the goal. The Goals are placed on the stack when the system recognizes a statement of a goal by the User (101) and the interpreter in the Task Manager (201) puts the goal on the stack (202). The interpreter than expands the new Goal and puts the associated Plan on the Plans Stack (205).

The Plans Module (205)

The Plans Module (205) keeps and maintains the current plan of actions of the system. The Plan define the specific Steps, Actions and Subgoals that when performed would achieve the related Goal. The Steps and Actions that make up a Plan are information access Steps, Speech-Acts performed toward the User (101) like ASKing for information, TELLing him a relevant Fact or LISTENing and interpreting semantically (107) the USFR's Response. The Actions may be Performing an external application transaction or sending a Query to a Back Office Data Base. Some time the plan step is a Subgoal that has to be expanded into its own steps when it is reached. The Plan steps are interpreted one by one asynchronously, by the Plan Interpreter (225) in the Task Manager (201) and the steps guide the interaction of the Task Manager (201) with all the other modules.

The application designer defines the top goals, also referred to as the application transactions, and their associated plans in one or more XML documents. The Task Manager loads those files on startup.

The Discourse Context (226)

The Dialog Context Tree Module (207)

The Dialog Context Tree Module (207) keeps and maintains the dynamic Structure of the Dialog as it is unfolding. The current Dialog Context is also kept In this Tree Structure. The Context is the collection of words and their meanings and relations, as they have been understood in the current Dialog. The Task Manager (201) Interpreter uses the Context Tree to understand the Pragmatics of the User Utterances (125) and to generate the Expectations of how the User may respond to the system query or request. The Expectations (222) are sent to the Expectation Module (211).

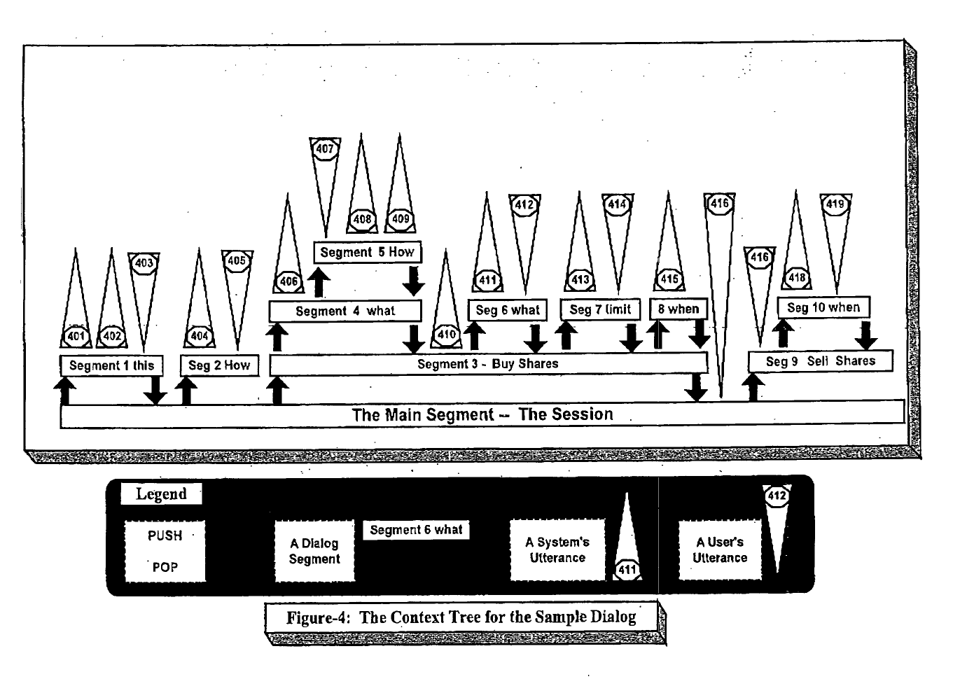

An example structure of the Context Tree is shown in FIG. 4.

The Current World Objects Module (209)

This Module keeps and maintains the Semantic Representation of the Objects in the real World that have been mentioned in the Dialog (and therefore are in the Context) and related Objects that are “Known by the System” and are needed to Understand the Utterances. For example; descriptions of the Knowledge about Stock Data Bases, Stock Proper Names that may be mentioned, Transaction Forms etc.

The Current World Object Module (209) is interrogated by the Dialog Manager Interpreter (208) (in the Task Manager (201)), according to specific requests and actions specified in the Current Plan which is maintained inside the Plans Module (205).

The Interpretation Manager (211)

When the Dialog Manager Interpreter (225) performs a LISTEN step in the Current Plan (205) it generates a set of expectations (222) to the Interpretation Manger (211). These Expectations are a set of Expectation Rules which describe “What” and “How” the system expects the User to respond to it's own Utterance.

In addition to the specific expectation message (222) from the Task Manager (201), the Interpretation manager is using its own rules and may integrate the Discourse Context (226) directly (227).

The IM (211) specific rules are used to complete the user utterance interpretation (212) done by the Syntactic/Semantic Parser (219) in the context of dialog. Most of the rules are domain independent and the rest are domain or application specific. The details of the IM (211) rules are outside the scope of this patent application.

The expectation message (222) is only covering what the user might say if he is to answer the question asked by the system. In cases where the user utterance is NOT an answer to the system last question, the IM (211) may need to query the DC (226) in order to completely resolve the meaning of the user utterance.

By comparing the Expectations with the actual User response, analyzed by the Syntactic/Semantic Parser (219) (or (107)) the system is able to recognize the User's Intentions, recognize if he wants to “seize the initiative” and decide better how the Dialog should proceed. This is the heart of the Systems' Mixed Initiative Behavior. It is explained in further details in the following Chapters.

A Sample Mixed Initiative Dialog

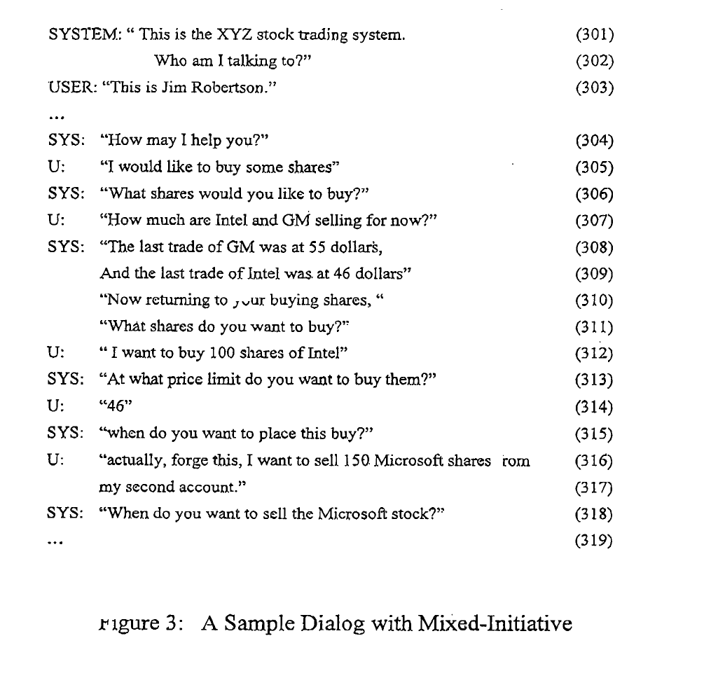

FIG. 3 presents a sample short Dialog where we can demonstrate most of the phenomena of mixed initiative dialogs. The sample dialog is between a Mixed Initiative capable Dialog System we call XYZ and a remote User calling over the phone. This is just a simple example of a wide diversity of possible behaviors.

(301) After noticing the RING, the SYSTEM starts the dialog with an OPENING segment where it introduces itself

(302) It then issues a question which is an ASK(Name) Speech Act.

(303) The USER answer as expected with his full name “Jim Robertson” . . . some additional Identification and Verification exchanges may ensue.

(304) The system ASKs for the User's Goal or Goals. It expects to get an indication as to what task be wants to perform (among those that the system knows about, understands and can help with.

(305) User states his Goal: he wants to perform a BUY-SHARES transaction.

(306) The system recognizes his intention and sets up BUY-SHARES as the Current Goal of the Dialog. It then opens up a fresh Dialog-Segment and keeping the Initiative it asks the needed Information-Items necessary before it can do the BUY Transaction.

(306) The first question is ASK(What Shares) and Expects a share Name.

(307) The User seizes the initiative and asks a related question. The relation is due to the fact that to select a Stock you may Ask about it's price in the market.

(308) The system answers the question with the results it obtains from the DB.

(309) “ ”

(310) It immediately seizes the initiative and returns to the BUY-SHARES segment.

(311) and it ASKs the same question again (this is how the logic was set)

(312) The user answers with a full answer, actually repeating his goal, giving Intel as the share name and adding the 100—the number of the shares to buy. All this is recognized by the system and is incorporated into the Transaction being defined.

(313) The system ASKs about the PRICE-LIMIT of the BUY.

(314) The user answers only 46! And the system understands this ellipsis (fragmented answer) by matching it with the Expectations! It takes the naked number and puts it in the PRICE-LIMIT field with Dollars units.

(315) The system ASKs (Time) about the time of the BUY.

(316) The User again seizes the initiative and first issues a QUIT(This) Speech-Act, and then proceeds to declare a new SETGOAL (SELL-SHARES) Transaction with Name=Microsoft and Quantity=150.

(317) He even states from which ACCOUNT to take the shares for SELL.

(318) The SYStem recognizes the seizing and the new Transaction and also Understands the Information-Items given to it out of Context. Now it seizes the initiative and asks about the time ASK(SELL(Microsoft, Time)) (319) and the Dialog continues.

The Dialog Structure Tree

Each numbered utterance in FIG. 4, for example (401), corresponds to the text utterance in FIG. 3 with the same last two digits (i.e., (301)).

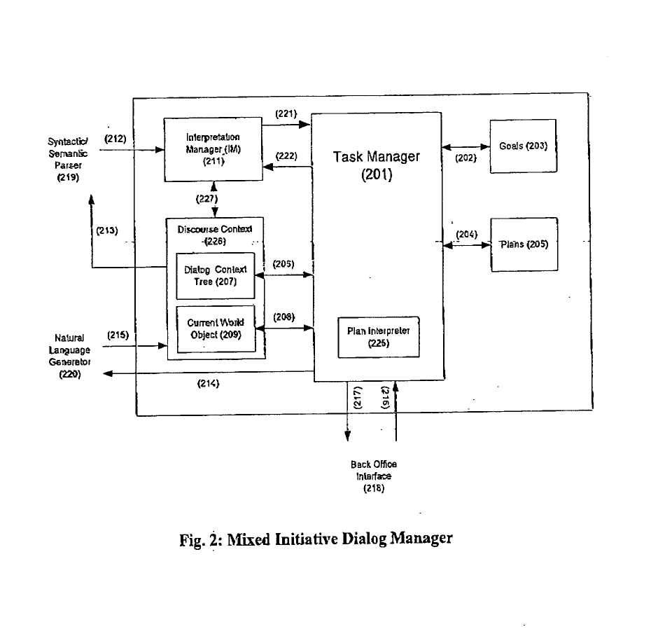

The Dialog Structure Tree represents the Dynamic State of the Dialog as it progresses. It is contained and maintained in the Dialog Context Tree Module (207) of FIG. 2. The Dialog Structure Tree depicted in FIG. 4 is a schematic of the Sample dialog in FIG. 3.

The Mixed Initiative Flow

FIG. 5 represents a State Diagram of the Flow of a typical Mixed Initiative Dialog. The ellipses represent the states of the sytems and the transitions, the arches represent Messages (Utterances) going from side to side.

The rectangle on the left represents the First Party (501) (FP) and it contains two main states: When the First Party Holds the Initiative (503), and when it recognized that the Second Party (502) Seized the Initiative (510) it goes into the Responsive State (504). The Dialog Starts (507) by the OPEN-DIALOG signal (e.g. the phone ringing) and initially Holds the Initiative (503). It generates a Greeting Message (508).

The rectangle on the right represents the Second Party (502) (mostly the User) and it also contains two main states. Holding the Initiative (506) and Responsive (505) to the First Party (501).

The Party Holding the Initiative may issue Commands, Requests, Questions or offer Information or Propose plans. The Other Party answers Responsively (505). A Responsive Reply from the Second Party (509) is a reply in the Expected Set of replies that the First Party (501) Expects. The First Party has to analyze the Reply (509) and Recognize it as an Expected Reply. This allows it to Understand the Meaning and the Intentions of the Second Party (502). It can then generate the Proper Mixed Initiative I-Reply (518).

We are describing here Mixed Initiative Dialogs which are defined as Dialogs between (almost equal) parties where both parties may dynamically Seize the Initiative or Release It as they see fit. But note that that the only signals that go between the parties are the Voice Utterances and the two patties have to signal each other, and the other party has to Recognize from the message itself what the other side decided.

The Second Party (502) can respond as requested (like, answer the question it was asked) like answering (312) to the question (311) in FIG. 3. This is considered Expected Reply (509). And the dialog will continue with exchanges of I-Replies (518) from the FP (501) and Expected Replies (509) from the Second Party (502).

At some point the SP (502) Seizes the Initiative (510) and it goes to the Holds Initiative state (506). With the Initiative “in its hands” the Second Party (502) can now may issue its Directives (511) (like Commands, Requests, Questions or offer Information or Propose plans) it can even Quit the Dialog by issuing a Quit message (512) and terminating the Dialog in (513).

All this “happened in SP's Head” (502) the FP (501) can only Hear (or See) SP Directives (511) analyze them and Recognize them as a Take the Initiative Utterances. It will then reply properly from it's Responsive state (504). The reply is again an I-Reply (514) which is a response which takes into account the Hold Initiative and Release Initiative of the other party the SP (502).

At some point the First Party (501) may decide to Take the Initiative (515) and he goes back into his Hold Initiative state (503). The Second Party Hears this transition only by analyzing the Utterance of the FP—the i-Reply.

The User on his side (the SP (502)) has to do the same Recognition action to identify if FP takes the initiative and issues commands or is just “responding as expected”, but the User is well trained and is proficient in Mixed Initiative Natural Language Dialogs. He is used to converse with people from age two or so.

The key component of the system that allows it to Recognize the Meaning and Intentions in the Other Party's Utterance is the Expectation Module (211) in FIG. 2.

The Dialog's Dynamic Expectations Table

FIG. 6 depicts a sample set of Rules Generated by Task Manager (201) for a Mixed Initiative proper I-Reply (518).

The Rules are sensitive to three type of features;

1. What was the system's last Speech-Acts or Utterance (e.g. SYS ASKed for information (see 602))

2. What was the Second Party's Speech-Act in relation to 1. (e.g. USER response is SA STATE-GOAL (NEW-GOAL) (603)

3. What was the Content=The Meaning of the USER response, in relation to the Semantic Concepts that are in the Current Dialog Context. (e.g. USER response is FRAGMENT) (and SUPERMATCH (FRAGMENT, EXPECTED)==>Succeeds)

The Rule or Rules that Match the situation will “Fire” and their RHS (Right Hand Side) will be activated. The activation may make changes in any or all of the following three levels.

4. It may give the requested information and change the Current Context (in 207) (e.g. see the Then side of (605, 606 and 607))

5. It may change the Dialog direction. (e.g. by issuing REQUEST CLARIFICATION GOAL)

6. It may add or change the Current GOAL. (e.g. by setting up a PUTGOAL( ) as in (601 602 and 603).

The present invention has been described with a certain degree of particularity, but those versed in the art will readily appreciate that various alternatives and modifications may be carried out without departing from the scope of the following claims.

1. A method for conducting an expectation based Mixed-Initiative Dialog between parties in natural language in order to perform at least one task, at least said first party being a machine, the method comprising the steps of:
a) the first party taking initiative;
b) the first party taking a turn in the dialog by generating at least one utterance; the semantics and pragmatics of said at least one utterance selectively fall in one of the following three levels 1) the current world model; 2) the dialog itself; and 3) the at least one task and at least one goal that the first party wants to perform; the speech acts, semantics and pragmatics implied expectations;
c) the second party, in response to said generated at least one utterance, taking a turn in the dialog and generating at least one reply utterance;
d) the first party interpreting the at least one reply utterance so as to create a semantic and pragmatic description thereof and the speech acts associated therewith; the first party checking whether the semantics pragmatics and speech acts of the at least one reply utterance fall within said implied expectations and if the affirmative
e) performing the steps (b) to (d) cycle as many times as required whilst the initiative is with the first party; during said cycles the first party selectively modifying any one of the levels 1) the current world model; 2) tie dialog itself; and 3) the at least one task and at least one:goal that the first party wants to perform; the second party being reponsive to the gnerated at least one utterance in said step (b) and generating at least one reply utterance in said step (c);
f) if the first party (in d) while checking whether the semantics, pragmatics and speech acts of the at least one reply utterance does not find it falling within said implied expectations, the first party identifying a change in the initiative which includes one of the following three levels:
(i) a change in the dialog goal, responsive to which the first party changing its current goal; or
(ii) a change in the dialog structure, responsive to which, the first party changing the dialog itself; or
(iii) a change in the current world model, responsive to which, the party changing the world model appropriately;
h) the first party generating at least an acknowledgement utterance indicating an acceptance of change in the initiative; the second party taking a turn and generating at least one utterance;
i) the first party interpreting the at least one utterance received in (h) so as to create a semantic and pragmatic description thereof and the speech acts associated therewith and derive therefrom the implied expectations of the second party;
j) the first party checking whether it can reply appropriately and generate at least one utterance which falls within the expectations derived in said (i), and if in the affirmative then the first party taking a turn in the dialog and generating as a response the at least one utterance;
k) performing the steps (h) to (j) cycle as many times as required whilst the initiative is with the second party
l) otherwise, if in response to said checking in step (j) the first party cannot generate at least one urrerance which falls within the expectations, the first party generating an utterance indicating that it takes the initiative; and after receiving an acknowledgement performing step (b).

2. The method of claim 1, wherein said second party being also a machine.

3. For use in claim 1, the steps executed by said first party.

4. For use in claim 1, the steps executed by said second machine.

5. For use in claim 2, the steps executed by said first party.

6. For use in claim 2, the steps executed by said first party.
